(19) United States
(12) Patent Application Publication
(10) Pub. No.: US 2022/0176728 A1
(43) Pub. Date: Jun. 9, 2022

(54) INK RESERVOIR UNIT FOR WRITING INSTRUMENTS AND WRITING INSTRUMENTS

(71) Applicant: MITSUBISHI PENCIL COMPANY, LIMITED, Tokyo (JP)

(72) Inventor: Shuji Ichikawa, Tokyo (JP)

(73) Assignee: MITSUBISHI PENCIL COMPANY, LIMITED, Tokyo (JP)

(21) Appl. No.: 17/436,832

(22) PCT Filed: Feb. 27, 2020
(86) PCT No.: PCT/JP2020/008011

§ 371 Date: Sep. 7, 2021

(30) Foreign Application Priority Data
Apr. 9, 2019 (JP) 2019-074061

(51) Int. Cl. B43K 7/02; B43K 7/00

(52) U.S. Cl. CPC B43K 7/02; B43K 7/005

(57) ABSTRACT

An ink reservoir unit for a writing instruments using an ink reservoir tube with which low contamination can be achieved considering environmental problems; and a writing instruments using the same. The ink reservoir tube is composed of a composite material in which a raw material is layered on a paper substrate having paper as a substrate. One end section of the ink reservoir tube is coupled to a connection part formed on a writing member or a relay member that holds the writing member to constitute the ink reservoir unit for a writing instrument. In one preferred aspect, a locking means using a male thread formed on an outer peripheral surface is provided to the connection part to be connected to the ink reservoir tube, and the ink reservoir tube is coupled to the relay member that holds the writing member by the locking means.

### BACKGROUND OF THE INVENTION

### Field of the Invention

The present invention relates to ink reservoir unit of writing instruments to be used for such as ballpoint pens and marking pens and to writing instruments.

### Description of the Related Art

As for an ink reservoir tube for a ballpoint pen, one tip end, such as a front tip end, of the ink reservoir tube is typically press-fitted to a ballpoint pen tip as a writing member or to a relay member holding a ballpoint pen tip.

A transparent or semi-transparent resin material, such as polypropylene, is used for the ink reservoir tube in order to secure the easiness of molding and visibility of the amount of ink.

In recent years, issues on microplastics flowing into the ocean become drawn attention, and efforts to solve global environmental problems such as reduction of the use of disposable plastics are growing. Several proposals focus on plastic-free materials for each part that make up a writing instrument; Patent Literature 1 discloses an ink reservoir tube material for writing instruments employing an ink reservoir tube having a multi-layer structure formed by molding one or two or more resin layers inside a reservoir base member made of biodegradable resin. The document recites that since the reservoir base member made of biodegradable resin biodegrades as the time lapses, this contributes to the lessening of the amount of synthetic resin to be disposed wastes.

Patent Literature 2 proposes a writing instrument provided with a barrel, which is made by spiral-forming of a composite material prepared by layering a synthetic resin having barrier characteristics or a metal such as aluminum on a paper base. The barrel for the writing instrument is made of materials having a layered structure that is composed of, from the outside, an aluminum-coated label paper whose backside is made of kraft paper, two liner-paper layers stacked, a polyethylene layer formed on the inner surface thereof, and a polyester layer with vapor-deposited aluminum outside. With this barrel, a writing instrument that allows achieving a lowering of pollution with maintaining durability by using composite materials containing a paper base can be provided.

### LIST OF REFERENCE

### Patent Literature

Patent Literature 1: JP-A-2001-146090
Patent Literature 2: JP-A-62-70097

### SUMMARY OF THE INVENTION

As described above, products using biodegradable resins and paper-based materials are appropriate for lowering pollution; products that take environmental problems into consideration can be provided if base materials containing pulp or paper that are alternatives to plastics are used.

The present invention is made from the above viewpoint and aims at achieving deplasticization by replacing ink reservoir tubes formed of polypropylene described in the beginning with those made of paper-based materials.

Composite materials containing paper-based materials are weak in mechanical strength compared to polypropylene or the like that are conventionally used. Accordingly, when the composite materials are employed in an ink reservoir tube, it is an important issue to devise a method to secure a certain connection strength at a connection part of an ink reservoir tube with a writing member or a relay member that holds a writing member.

One of the principal issues to be solved by the present invention is to provide an ink reservoir unit for writing instruments using an ink reservoir tube which takes an environmental problem into consideration that can achieve low pollution. Another principal issue is to provide an ink reservoir unit of high practicality for writing instruments and a writing instrument using the ink reservoir tube, by constructing to secure a certain connection strength at a connection part of an ink reservoir tube with a writing member or a relay member holding a writing member.

The technical features of the ink reservoir unit for writing instruments according to the present invention are that the ink reservoir tube is formed of a paper-based material and that one end of the ink reservoir tube is attached to a connection part formed on a writing member or a relay member holding a writing member.

In this case, a locking means is desirably equipped to secure a certain connection strength for the ink reservoir tube at a connection part of a writing member or a relay member holding a writing member. As an example, a first locking means using a male thread formed on an outer peripheral surface of the ink reservoir tube at the connection part is provided. As another example, a second locking means is provided in which a tapered face whose diameter is expanding toward the tip end of a writing member and a plurality of annular locking portions that sharply reduces the diameter continuously from the tapered face is formed along an axis direction.

As still another example, a third locking means is provided in which a plurality of protrusions each having a tapered face gradually rising toward the tip end of a writing tip and a falling portion whose diameter reduces at an acute angle following the tapered face is discontinuously formed along a circumferential and axial direction.

In addition, another configuration is also suitably employed where a ring-shaped reinforcing member is fitted to an outer peripheral surface of the ink reservoir tube at the connection part where the ink reservoir tube and a writing member or a relay member holding a writing member are connected.

Further, another configuration is also suitably employed where a reinforcing member with a C-shaped cross-section perpendicular to the axis is fitted on the outer peripheral surface of the ink reservoir tube at the connection part where the ink reservoir tube is connected with a writing member or a relay member holding a writing member.

As one of locking means capable of securing a certain strength for an ink reservoir tube, a fourth locking means is usable that is composed of a tapered portion formed on a writing member or a relay member to which the front end of the ink reservoir tube is inserted and a fastening ring having a press-contact surface which is pressingly contacted to an outer surface of the ink reservoir tube at the tapered portion. In the above case, a female thread is desirably formed on the fastening ring that is to be screwed with the male thread formed on the writing member or the relay member.

As another one of locking means, a fifth locking means can be used which includes a cylindrical body formed on the writing member or the relay member and to which the front end of the ink reservoir tube is inserted, a garter spring (an annular spring) that is housed in the bottom portion of the cylindrical body and pressingly in contact with the front end of the ink reservoir tube, and a pressing ring housed in the cylindrical body to position the garter spring at the bottom portion of the cylinder.

The writing instrument according to the present invention is constituted by housing into the barrel the ink reservoir unit for writing instruments including each of the locking means. Or, the writing instrument according to the present invention is constituted by housing into the barrel the ink reservoir unit for writing instruments formed by including each of the locking means and further combining with the reinforcing members. Further, the writing instrument according to the present invention is constituted that an ink reservoir tube in an ink reservoir unit forms a barrel serving as a grip. Or the writing instrument according to the present invention is constituted that an ink reservoir tube in an ink reservoir unit provided with each of the locking means and the reinforcing members forms a barrel serving as a grip.

According to the present invention, with the use of paper-based material for the material of the ink reservoir tube, an ink reservoir unit for writing instruments can be provided that takes an environmental problem that can achieve the reduction of the amount of plastics usage into consideration.

Further, an ink reservoir unit of high practicality for writing instruments can be provided having a certain connection strength and a writing instrument using the ink reservoir unit by providing each of the above described locking means for the ink reservoir tube to a writing member or a relay member holding a writing member.

### BRIEF DESCRIPTION OF THE DRAWINGS

FIG. 1A and FIG. 1B show a first embodiment of an ink reservoir unit according to the present invention, where FIG. 1A is an elevation and FIG. 1B is a central cross-sectional view;

FIG. 2A through FIG. 2C show appearance constitution of a second embodiment of the ink reservoir unit for writing instruments where a writing member and an ink reservoir tube are separated; FIG. 2A is a perspective view of the principal member, FIG. 2B is a front view of the principal member, and FIG. 2C is an enlarged cross-sectional view of the principal member;

FIG. 3A through FIG. 3C show appearance constitution of a third embodiment of the ink reservoir unit for writing instruments where a writing member and an ink reservoir tube are separated; FIG. 3A is a perspective view of the principal member, FIG. 3B is a front view of the principal member, and FIG. 3C is an enlarged cross-sectional view of the principal member;

FIG. 4A through FIG. 4C show appearance constitution of a fourth embodiment of the ink reservoir unit for writing instruments where a writing member and an ink reservoir tube are separated; FIG. 4A is a perspective view of the principal member, FIG. 4B is a front view of the principal member, and FIG. 4C is an enlarged cross-sectional view of the principal member;

FIG. 5A through FIG. 5C show appearance constitution of a fifth embodiment of the ink reservoir unit for writing instruments; FIG. 5A is perspective view of a reinforcing member before attached, FIG. 5B is an enlarged perspective view of a principal member, and FIG. 5C is an enlarged perspective view of the principal member with the reinforcing member attached;

FIG. 6 is an enlarged cross-sectional view of the ink reservoir unit for writing instruments shown in FIG. 5A through 5C;

FIG. 7A through FIG. 7C show appearance constitution of a sixth embodiment of the ink reservoir unit for writing instruments; FIG. 7A is perspective view of a reinforcing member before attached, FIG. 7B is an enlarged perspective view of a principal member, and FIG. 7C is an enlarged perspective view of the principal member with the reinforcing member attached;

FIG. 8A and FIG. 8B show a seventh embodiment of the ink reservoir unit for writing instruments; FIG. 8A is a central cross-sectional view and FIG. 8B is an enlarged cross-sectional view of a principal member;

FIG. 9A and FIG. 9B show a state where a writing member and an ink reservoir tube are separated with regard to an eight embodiment of an ink reservoir unit; FIG. 9A is a front view, FIG. 9B is a cross-sectional view;

FIG. 10A is an enlarged cross-sectional view of a principal member in a state where a writing member and an ink reservoir tube are separated and FIG. 10B is an enlarged cross-sectional view of a principal member in a state where an ink reservoir tube is connected to a writing member, both with regard to the ink reservoir unit shown in FIG. 9A and FIG. 9B;

FIG. 11A and FIG. 11B show an entire constitution of a first embodiment according to the present invention; FIG. 11A is a front view of the writing instrument with a clip positioned upper side and FIG. 11b is a central cross-sectional view thereof;

FIG. 12 and FIG. 12B show an entire constitution of a second embodiment of a writing instrument according to the present invention; FIG. 12A is a perspective view of the writing instrument with a cap detached and FIG. 12B is a central cross-sectional view thereof; and

FIG. 13A through FIG. 13C show an entire constitution of a writing instrument according to a third embodiment; FIG. 13A is a perspective view of the writing instrument and FIG. 13B is a front view thereof and FIG. 13C is a central cross-sectional view thereof.

### DESCRIPTION OF THE PREFERRED EMBODIMENTS

An ink reservoir unit and a writing instrument using the ink reservoir unit will be described on the basis of embodiments shown in the drawings. In the drawings below, parts and members functioning the same are indicated with the same referential numerals and the description to be duplicated will be properly omitted.

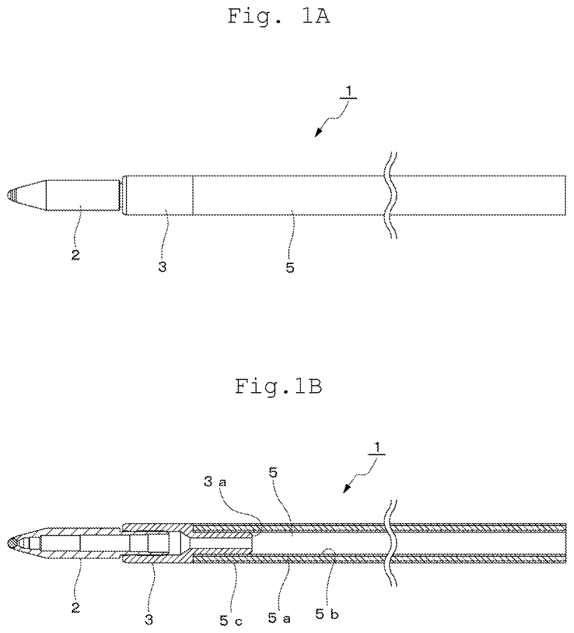

FIG. 1 shows a first embodiment of an ink reservoir unit for writing instruments, and a ballpoint pen tip 2 provided with a writing ball at a tip end is used as a writing member constituting the ink reservoir unit 1 for writing instruments.

In the first embodiment, a ballpoint pen tip 2 made of stainless steel is press-fittedly attached to a relay member 3 made of a metal material. A connection part 3a of an ink reservoir tube having a reduced diameter is formed at the rear half portion of the relay member 3, and a front end of the ink reservoir tube 5 is connected by fitting with covering the connection part 3a.

In the first embodiment, the connection part 3a of the ink reservoir tube is formed to be a straight cylinder. A certain connecting strength can be imparted to the connected-by-fitting ink reservoir tube 5 by applying an adhesive, for example, to the connection part 3 in advance.

The ink reservoir tube 5 described in this embodiment has a three-layer structure as shown in FIGS. 1B and 1s composed of an inner layer 5b, which is in contact with ink (not shown), a base layer 5a in the middle, and an outer layer 5c covering the base layer 5a.

The base layer 5a in the middle is formed of a paper-based material, the inner layer 5b is made of a resin material or aluminum, and further, the outer layer 5c is made of a resin material.

The paper-based material of which the base layer 5a is made is mono-layered or multilayered material, and is desirably excellent in bending resistance for molding, drop impact absorption, and water resistance at the end face.

The paper-based material is a sheet-shaped material mainly made of pulp, and may additionally include fillings, and different auxiliary materials. The pulp is chemical pulp, mechanical pulp, non-wood fiber, and others, and a proper mixture of those materials is also usable.

The resin material that constitutes the inner layer 5b is desirably easy forming and not soluble to a water-base or oil-based ink; that is, the ink does not penetrate up to the base layer 5a.

In addition, the resin material is desirably acrylic resin, polystyrene, fluoric resin, silicone, or a combination thereof, or biodegradable plastics such as polylactic acid resin from the viewpoint of high strength, easiness of handling, and availability. Biodegradable plastics are preferable as an environmentally friendly material for the ink reservoir tube as long as possibly imparted with the necessary strength and lifetime as the ink reservoir tube.

The inner layer 5b, when constituted with an aluminum layer as described above, is soluble neither to water-based nor oil-based ink and surely prevents the penetration of ink up to the base layer 5a made of paper-based material.

The resin material that constitutes the outer layer 5c, similar to the resin material that constitutes the inner layer 5b, is desirably easy forming and not soluble to a water-base or oil-based ink and does not penetrate to the base layer 5a.

Further, the resin material that does not absorb moisture in the outer air is desirable.

As the resin materials constituting the outer layer 5c, similar resin materials are cited to those that constitute the inner layer 5b. Both resin materials may be the same or different.

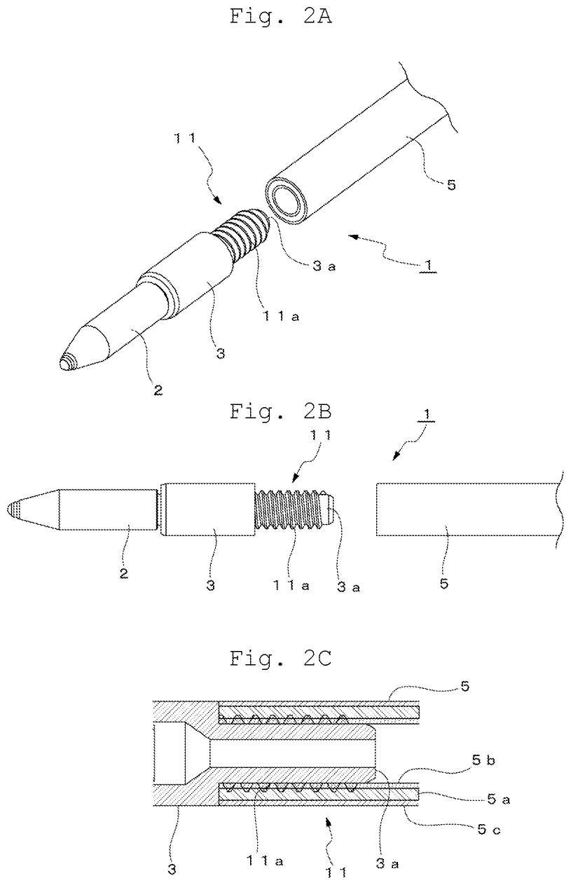

FIGS. 2A through 2C show a second embodiment of an ink reservoir unit. In the ink reservoir unit 1 in the embodiment, on a connection part 3a of an ink reservoir tube formed on a relay member, a male thread 11a is made along the outer circumference of the connection part 3a, and the male thread 11a constitutes a first locking means.

According to the second embodiment, a front end of the ink reservoir tube 5 is connected by screwing to the male thread formed on the connection part 3a of the relay member 3. FIG. 2C shows a state where the ink reservoir tube 5 is connected with the connection part 3a of the relay member 3 by screwing the front end of the ink reservoir tube 5 to the male thread 11a.

According to the second embodiment, the higher connection strength of the ink reservoir tube 5 with the connection part 3a can be more secured compared to the ink reservoir unit for writing instruments described in the first embodiment shown in FIGS. 1A and 1B.

As shown in the cross-sectional view in FIG. 2C, a three-layer structure is also employed similar to the first embodiment for the ink reservoir tube 5 described in the second embodiment.

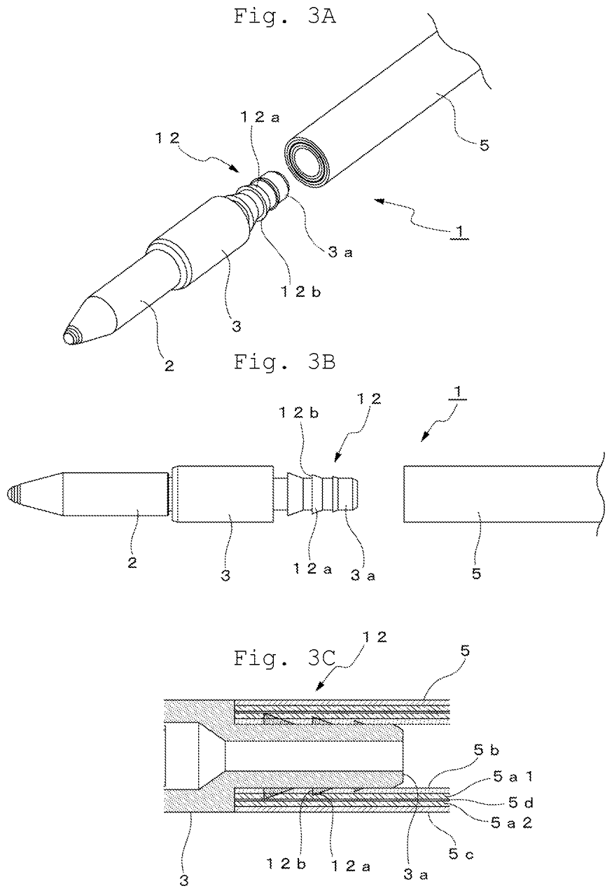

FIGS. 3A through 3C show a third embodiment of an ink reservoir unit for writing instruments. In the ink reservoir unit 1 in the embodiment, multiple, three in the figure, annular locking members 12 are formed along the axial direction on a connection part 3a of the ink reservoir tube formed on the relay member 3.

Each of the annular locking members 12 is provided with a tapered face 12a whose diameter is expanding toward the tip end of a ballpoint pen tip 2 and a falling down portion that reduces the diameter at an acute angle following the tapered face 12a is formed.

The annular locking member 12 that has the tapered surface 12a and the falling portion 12b is formed to have increased outer diameter sequentially along with going toward the tip end of the ballpoint pen tip 2; this structure constitutes a second locking means, indicated by the same referential number as the locking member 12.

According to the second locking means 12 shown in the third embodiment, by pushing the front end of the ink reservoir tube 5 toward the tapered face 12a formed on the annular locking member 12, the front end opening of the ink reservoir tube 5 is enlarged by the tapered face 12a and is connected to cover the connection part 3a.

In a state in which the front end of the ink reservoir tube 5 is connected with the connection part 3a as shown in FIG. 3C, the falling portion 12b functions similarly as the barb of a fishing hook, effectively preventing the ink reservoir tube 5 from coming off from the connection part 3a.

A five-layer structure is used for the ink reservoir tube 5 in the third embodiment. As shown in FIG. 3C, the ink reservoir tube includes an inner layer 5b, a first base layer 5al, a resin layer 5d, a second base layer 5a2, and an outer layer 5c.

The first base layer and the second base layer are both composed of the similar paper-based material as the layer 5a in the middle described based on FIG. 1. The inner layer 5b, the resin layer 5d, and the outer layer 5c may be composed of the same material or different materials to each other. When the same material is used, a resin material similar to the material used for the inner layer 5b described based on FIG. 1 can be suitably used. Further, for the case where the ink reservoir tube 5 has a five-layer structure, such a structure in which only the inner layer 5b is made of an aluminum layer also can be adopted.

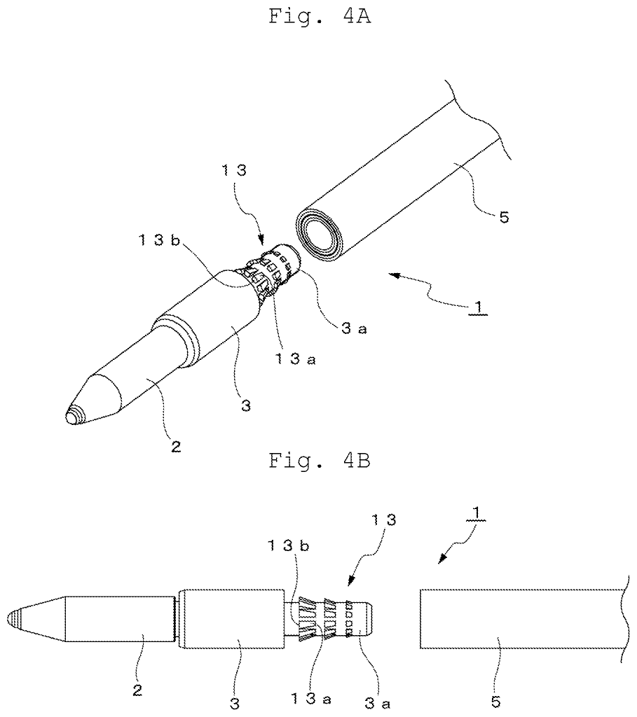

FIG. 4 shows a fourth embodiment of an ink reservoir unit for writing instruments. The ink reservoir unit for writing instruments 1 described in the embodiment includes a structure of a third locking means (with the same referential number that is for the protrusion 13) where a plurality of protrusions 13 is discontinuously formed on a connection part 3a formed on a relay member 3 along with the circumferential and axial directions.

Further, each of the protrusions 13 has a tapered face 13a that gradually rises toward a ballpoint pen tip 2 and a falling portion 13b that falls at an acute angle continuously from the tapered face 13a, and the height of each of the protrusions increases toward the tip of the ballpoint pen tip 2.

Each of the protrusions 13 formed is equivalent to those that three lines of annular locking members having the tapered face 12a and the falling down portion 12b being parted by a plurality of grooves formed along the axial direction.

Accordingly, the cross-sectional view of the connection part 3a shown in FIG. 4 is nearly the same as the cross-sectional view shown in FIG. 3C.

Because the plurality of protrusions having tapered faces 13a and falling portions 13b are provided in the third locking means 13 shown in the fourth embodiment, an ink reservoir tube 5 is relatively easily attach by pushing the front end of the ink reservoir tube 5 into the connection part 3a. Further, in a state where the ink reservoir tube 5 is connected to the connection part 3a, the falling portion 13b acts to prevent the ink reservoir tube 5 from detaching from the connection part 13a, which is a similar action to those in the example shown in FIG. 3.

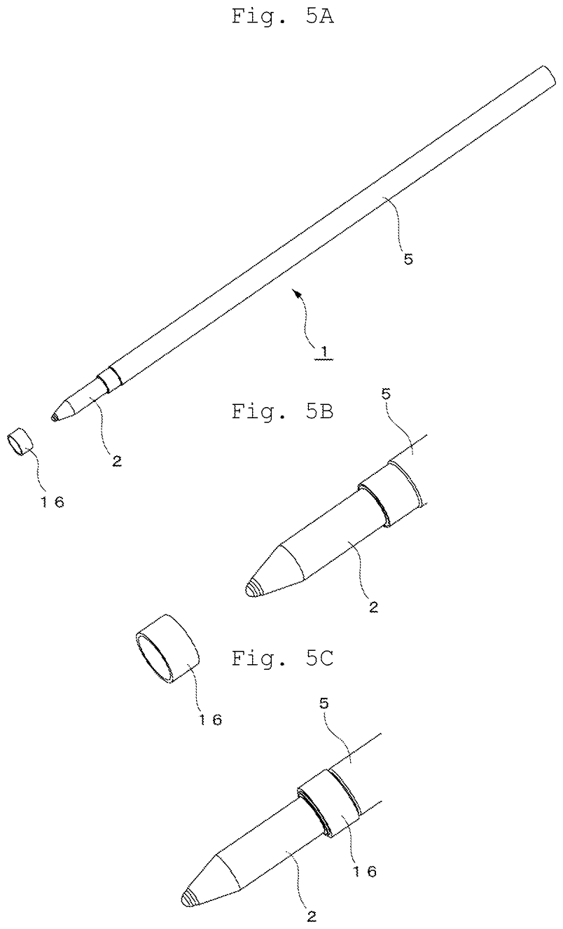

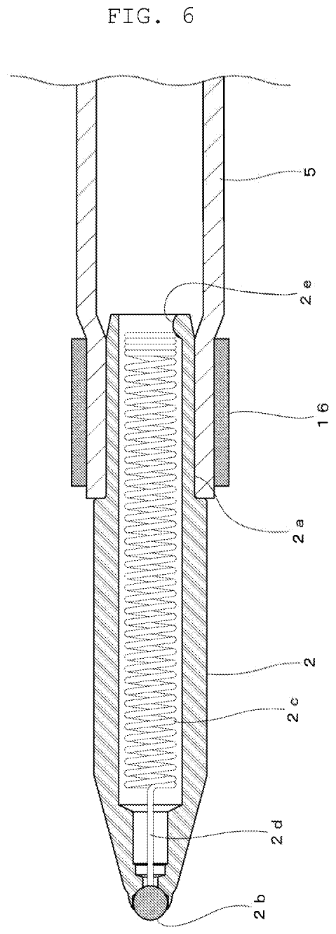

FIGS. 5A, 5B, and 5C and FIG. 6 show a fifth embodiment of an ink reservoir unit for writing instruments. In the ink reservoir unit for writing instruments 1 illustrated in this embodiment, as shown in an enlarged cross-sectional view in FIG. 6, a connection part 2a is formed having a reduced diameter at a rear half portion of a ballpoint pen tip 2, and an ink reservoir tube 5 is connected so as to cover the connection part 2a. Further, a ring-shaped reinforcing member 16 is fitted along the outer peripheral surface of the ink reservoir tube 5 that is connected to the connection part 2a of the ballpoint pen tip 2.

The reinforcing member 16 is mounted from the front end of the ballpoint pen tip 2 as shown in FIG. 5 such that the reinforcing member is brought pressingly into contact to the front end portion of the ink reservoir tube 5 connected to connection part 2a along the outer peripheral surface of the ink reservoir tube 5, whereby the connection between the ballpoint pen tip 2 and the ink reservoir tube 5 is assured.

The ink reservoir tube 5 shown in FIG. 5A is illustrated with a single-layer structure, but a three-layered or a five-layered ink reservoir tube 5, previously described, may be employed as appropriate.

A well-known writing ball 2b is mounted at the tip end of the ballpoint pen tip 2 shown in FIG. 6 and in this embodiment a spring 2c is mounted in an inner space of the ballpoint pen tip 2. The tip end of the spring 2c is formed to constitute a push rod 2d formed in a straight rod, and the push rod 2d presses the writing ball 2b to the tip end direction.

A part of the rear end of the ballpoint pen tip 2 is caulked inward and the caulked portion locks the rear end of the spring 2c.

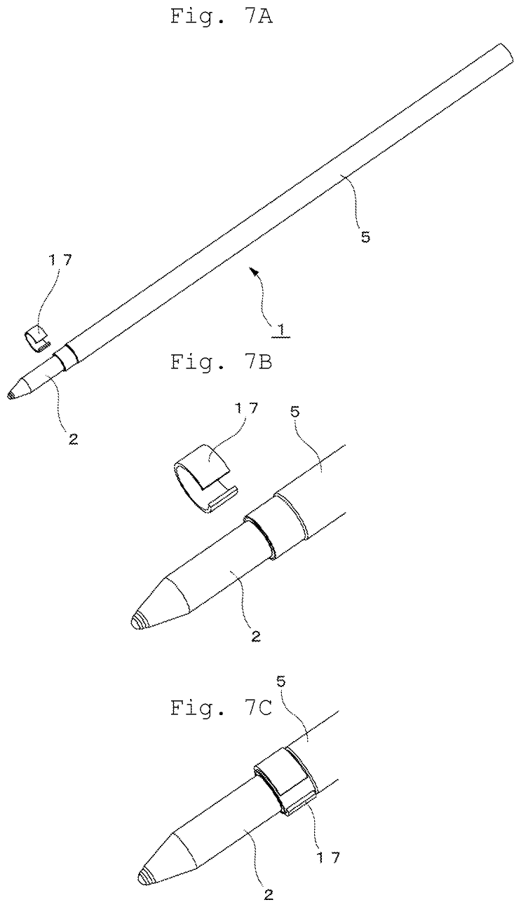

FIGS. 7A, 7B, and 7C show a sixth embodiment of an ink reservoir unit for writing instruments. In the ink reservoir unit for writing instrument 1 illustrated in this embodiment, similar to examples in FIGS. 5A, 5B, and 5C and FIG. 6, a connection part 2a is formed by reducing the diameter of the rear half of the ballpoint pen tip 2, and the ink reservoir tube 5 is connected to cover the connection part 2a.

Further, a reinforcing member 17, having a C character shape cross-section in a perpendicular direction to the axis, is fitted along the outer peripheral surface of the ink reservoir tube 5 that is connected to the connection part 2a of the ballpoint pen tip 2.

The reinforcing member 17 is mounted from the front end of the ballpoint pen tip 2 such that the reinforcing member is brought pressingly into contact to the front end portion of the ink reservoir tube 5 along the outer peripheral surface of the ink reservoir tube 5 connected to a connection part 2a.

The connection of the ink reservoir tube 5 to the ballpoint pen tip 2 is surely connected since the reinforcing member 17 is formed to have a C character shape cross-section in a perpendicular direction to the axis and has a diameter-reducing spring characteristic.

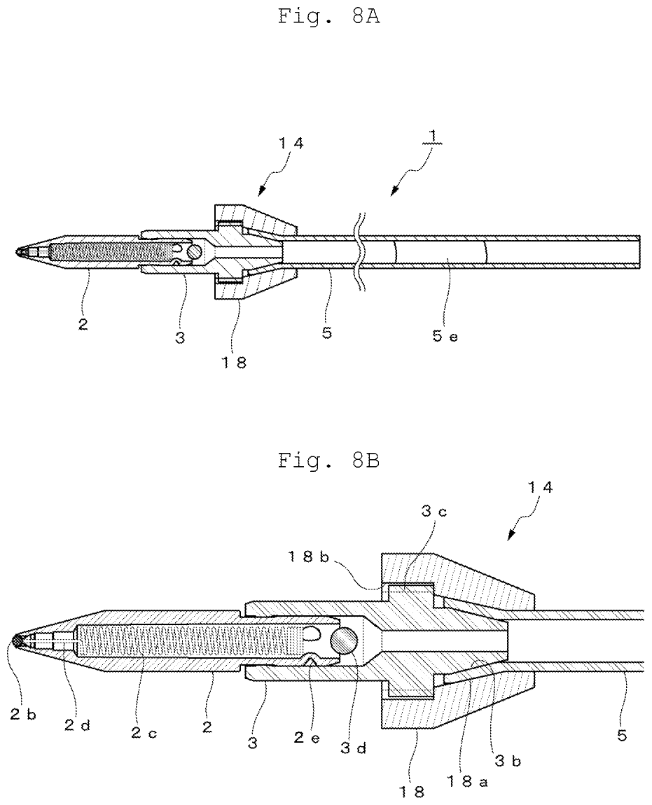

FIGS. 8A and 8B show a seventh embodiment of the ink reservoir unit.

In the ink reservoir unit 1 illustrated in this embodiment, a tapered portion 3b, to which the front end opening of the ink reservoir tube 5 is to be inserted, is formed at the rear end of the relay member 3 that holds a ballpoint pen tip 2.

A fastening ring 18 is provided having a press-contact surface 18a that is pressingly in contact to the outer surface of the ink reservoir tube 5 at the tapered portion 3b, whereby a fourth locking means is constructed.

The fastening ring 18 is provided with a female thread 18b that is screwed with a male thread 3c formed on the relay member 3. By tightening the female thread 18b of the fastening member 18 to the male thread 3c of the relay member 3, a cone-shaped press-contact surface 18a formed on the fastening ring 18 is brought pressingly into contact, from the outside, with the front end of the ink reservoir tube 5 mounted on the tapered portion 3b of the relay member 3.

With this, ink reservoir tube 5 can be surely attached to the relay member 3.

The ink reservoir tube 5 shown in FIG. 8 is illustrated with a single-layer structure, but a three-layered or a five-layered ink reservoir tube 5, which is previously described, may be employed as appropriate.

The referential sign 5e shown in FIG. 8A indicates a publicly known backflow preventive body or follower that is in contact with the back end of the ink in the ink reservoir tube 5 and advances following the consumption of the ink.

Further, the referential sign 3d shown in FIG. 8B indicates a backflow preventive ball that prevents air from entering from the tip end of the ballpoint pen tip 2 by closely contacting with the axial bore formed in the relay member 3 when the writing instrument is stored with the ballpoint pen tip 2 upward.

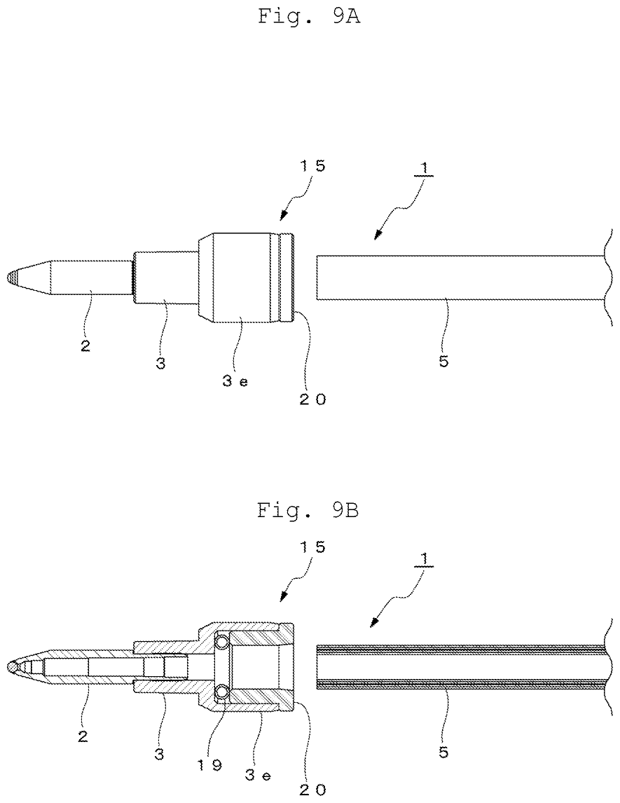

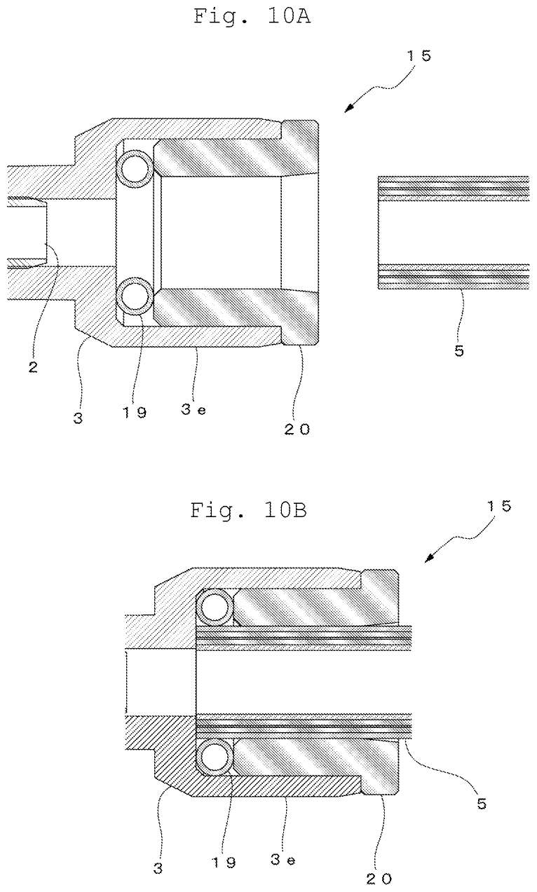

FIGS. 9A and 9B and FIGS. 10A and 10B show an eighth embodiment of the ink reservoir unit. In the ink reservoir unit illustrated in this embodiment, a tubular body 3e to which the front end of the ink reservoir tube 5 is integrally formed with the relay member 3 that holds the ballpoint pen tip 2. The fifth locking means 15 of the ink reservoir tube 5 is constructed by including a garter spring, an annular spring, that is housed in the bottom of the tubular body 3e and pressingly in contact with the tip end of the ink reservoir tube 5 and a press ring 20 that is mounted in the tubular body 3e and locates the garter spring 19 at the inner bottom of the tubular body 3e.

The garter spring is a coil spring connected in a circular shape. The diameter of one end of the coil spring is gradually reduced toward the distal end, and the coil spring is connected annularly by inserting the reduced end to the other end.

In this embodiment, the inner diameter of the garter spring 19 is formed smaller than the outer diameter at the front end of the ink reservoir tube 5. The garter spring is housed in the bottom of the tubular body 3e formed in the relay member 3 and further, is positioned at the inner bottom of the tubular body 3e by a press ring 20 inserted in the tubular body 3e.

Consequently, by inserting the front end of the ink reservoir tube 5 toward the opening of the press ring 20, the diameter of the garter spring 19 is expanded by the tip end of the press ring 20 and the garter spring can grip the tip end of the press ring 20.

The garter spring is held at the inner bottom of the tubular body 3e formed in the relay member 3 by the press ring 20 and the state where the ink reservoir tube 5 is connected with the relay member 3 by way of the garter spring 19 is maintained. Thus, with the fifth locking means 15, a fitting action excellent in the durability that the garter spring 19 has can be achieved.

As for the ink reservoir unit 1 described above, examples shown in FIGS. 8A and 8B, FIGS. 9A and 9B, and FIGS. 10A and 10B show the state where the connection part formed in the relay member 3 that holds a ballpoint pen tip 2 is connected to the front end of the ink reservoir tube 5. However, another construction can be adopted in which the ballpoint pen tip 2 is directly connected to the front end of the ink reservoir tube 5.

Further, examples illustrated in FIGS. 5A, 5B and 5C, FIG. 6, and FIGS. 7A, 7B and 7C show the state where the ballpoint pen tip 2 is directly connected to the front end of the ink reservoir tube 5. However, another construction can be adopted in which the connection part formed in the relay member holding the ballpoint pen tip 2 is connected to the front end of the ink reservoir tube 5.

As for the ink reservoir unit 1 described above, examples are shown in which the ink reservoir tube 5 has a three-layered or a five-layered structure using paper-based materials. The use of an ink reservoir tube with a two or more layer structure having a resin or aluminum layer on at least an inner layer on a paper base contributes to providing an environment-friendly ink reservoir unit for writing instruments which reduces the amount of plastic used.

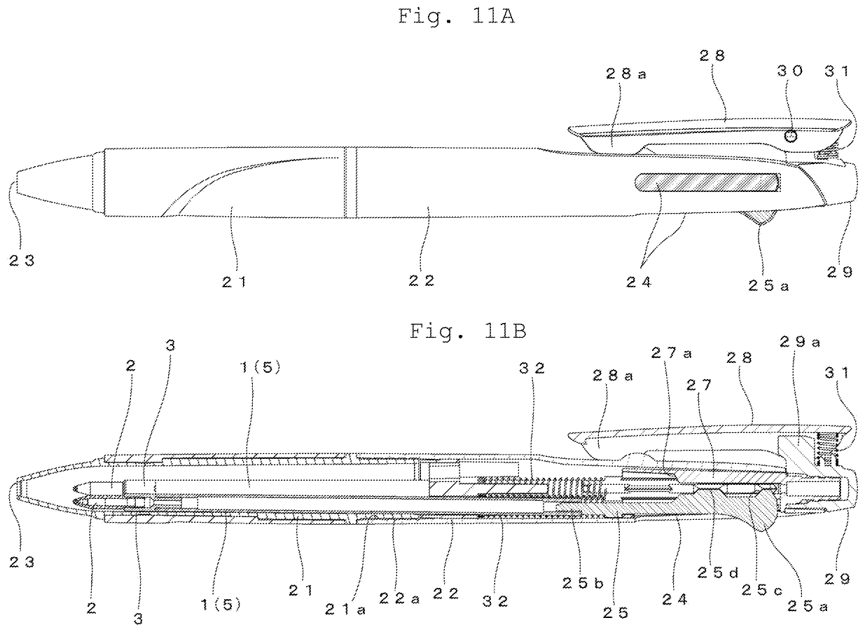

FIGS. 1A and 1B show a first embodiment of a writing instrument using the above-described ink reservoir unit. This embodiment illustrates an example of a composite writing instrument, for example, that houses a plurality of ink reservoir units for writing instruments 1 shown in FIG. 1A in a barrel. The composite writing instrument has a barrel composed of a front barrel 21 and a rear barrel 22. As shown in a cross-sectional view in FIG. 11B, the front barrel 21 and the rear barrel 22 are detachably connected in the axial direction by screwing the male thread 21a formed on the rear outer peripheral surface of the front barrel 21 with the female thread 22a formed on the front inner circumferential surface of the rear barrel 22.

The tip end of the front barrel 21 is cone-shaped with a reducing diameter and has a tip end opening 23. One of the writing members 2, such as a ballpoint pen tip, of the ink reservoir unit 1 is configured to alternatively advance from the tip end opening 23.

A plurality of guiding slots 24, three in this case, is formed each along the axial direction on the rear end of the rear barrel 22. An operating portion 25a formed on the slider 25 protrudes out from the outer peripheral surface of the rear barrel 22 through the corresponding guiding slots 24 and is disposed slidably in the axial direction.

In the rear barrel 22 to which guiding slots are formed, an inner cylindrical member 27 is housed to be positioned inside of the guiding slots 24 A locking face 27a that acts to lock the slider 25 in an advanced state is formed on the inner cylindrical member 27.

The rear end portion of the inner cylindrical member 27 is formed to have a small diameter and protrudes slightly from the rear end portion of the rear barrel 22. A cap 29 to which a clip 28 is to be mounted is locked and attached to cover the protruding portion of the inner cylindrical member 27.

An attachment base 29a for the clip 28 is integrally formed with the cap 29. The clip 28 is rotatably attached to the cap 29 with a shaft 30 penetrating the attachment base 29a. Further, a coil spring 31 is mounted between the cap 29 and the clip 28. A clip ball 28a formed on the tip end of the clip 28 is configured to be lightly pressingly in contact with the side surface of the rear barrel 22 by the biasing force of the coil spring 31.

An ink reservoir unit mounting part 25b formed at the front end of the slider 25 is press-fitted to the rear opening of the ink reservoir tube 5 in the ink reservoir unit 1.

A return spring 32 is attached to surround the respective ink reservoir tube 5 and slider 25, and which are disposed in the barrel in a biased state toward the rear side by the return spring 32.

When the operating portion 25a of one of the sliders 25 is moved forward in this state, the operating portion 25a of the slider 25 is moved forward along a groove formed in the inner cylindrical member 27 and falls toward the axial direction of the barrel. This causes the rear locking portion 25c of the slider 25 to be locked to the locking face 27a formed on the inner cylindrical member. At this point, the ink reservoir unit 1 attached to the slider 25 bends properly due to its flexibility, and the ballpoint pen tip 2 of the ink reservoir unit is held in a delivered state from the tip end opening 23.

In addition, when a second slider 25 is moved forward, a locking release cam 25d formed on the second slider 25 abuts on the rear end locking portion 25c of the first slider 25 which is already locked in a delivered state, and the locking release cam 25d pushes the rear end locking portion 25c of the first slider 25 outside, whereby the locked state of the first slide 25 is released.

As a result, the first slider 25 retracts due to the action of the return spring 32, and the rear end locking portion 25c of the second slider 25 is locked to the locking face 27a formed in the inner cylindrical member 27; thus, the ballpoint pen tip 2 delivered from the tip end opening 23 can be exchanged.

The composite writing instrument shown in FIGS. 11A and 11B is an example of a use of the ink reservoir unit according to the present invention. The ink reservoir unit according to the present invention can be used in a ballpoint pen writing instrument having a single ink reservoir unit housed in the barrel, not only for the composite writing instrument shown in FIGS. 11A and 11B.

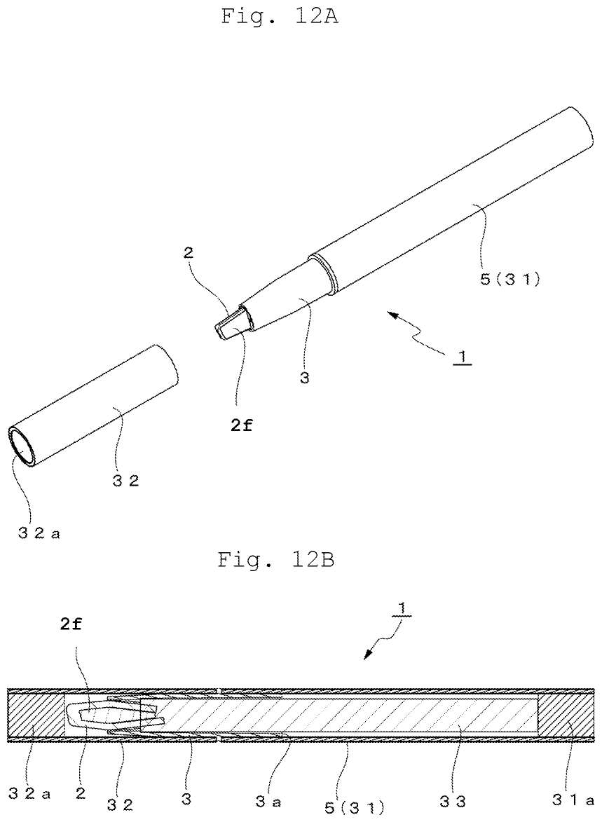

FIGS. 12A and 12B show a second embodiment of the writing instrument according to the present invention. The second embodiment is characterized in that the ink reservoir tube is composed of a paper-based material and the ink reservoir tube constitutes a barrel as a grip of the writing instrument.

The writing instrument shown in FIGS. 12A and 12B is a writing instrument called “an underscoring pen” and allows drawing bold lines with the provision of a thick writing member 2.

Synthesized resin fibers bundled to a rod shape or a porous material made of sintered high-molecular material is used for the writing member 2 at the tip end for an underscoring pen of this kind. An ink supplied from the ink reservoir tube 5 of the writing instrument body is lead to the writing member 2 and allows writing lines.

In association with the widespread of underscoring pens having ink reservoir tubes 5 containing fluorescent ink, a variety of underscoring pens allowing drawing thick lines are provided.

Users can make a wide selection of underscoring pens depending on their usage and the workability becomes comfortable.

As for the writing instrument in FIGS. 12A and 12B, the ink reservoir tube 5 of the ink reservoir unit for writing instruments 1 is formed to a cylindrical shape, also serving as a barrel 31 as a grip. As described above, the ink reservoir tube 5 is composed of a paper-based material, and more preferably an ink reservoir tube composed of two or more layers including a resin or aluminum layer as the inner layer is used.

A three-layered structure shown in FIG. 1B or a five-layered structure shown in FIG. 3C, for example, can be employed for the ink reservoir tube 5 as appropriate.

The tail end of the ink reservoir tube 5 which also serves as a barrel 31 is closed with a tail cap 31a, and the front end of the ink reservoir tube 5 is connected by fitting with the connection part 3a formed on the rear half of the relay member 3. Further, a writing member 2 is attached to the tip end of the ink reservoir tube 5 by way of the relay member 3.

The writing member 2 is formed by attaching an approximately U-shaped porous member along the outer periphery of a transparent flat-plate support member 2c.

An ink occluding body 33 to which ink is impregnated is housed in the ink reservoir tube 5, and the ink from the ink occluding body 33 is supplied to the porous member composing the writing member 2. With this, the writing member 2 allows the drawing of lines.

Since a window-shaped visible portion is formed on the writing member 2 by using a transparent support member 2c for the writing member 2, characters printed on the paper can be recognized through the visible portion. This allows drawing lines accurately with the writing member 2.

For the writing instruments shown in FIGS. 12A and 12B, a cap 32 to cover the writing member 2 is prepared; the cap 32 is preferably formed of a paper-based material similar to the ink reservoir tube 5 which also serves as the barrel 32.

To form a cap 32, a sealing plug 32a made of a similar material to the tail cap 31a is attached to a crown part of the cap 32. The cap 32 is detachably mounted to the body of the writing instrument, by being mounted on a front half portion of the relay member 3 holding the writing member 2.

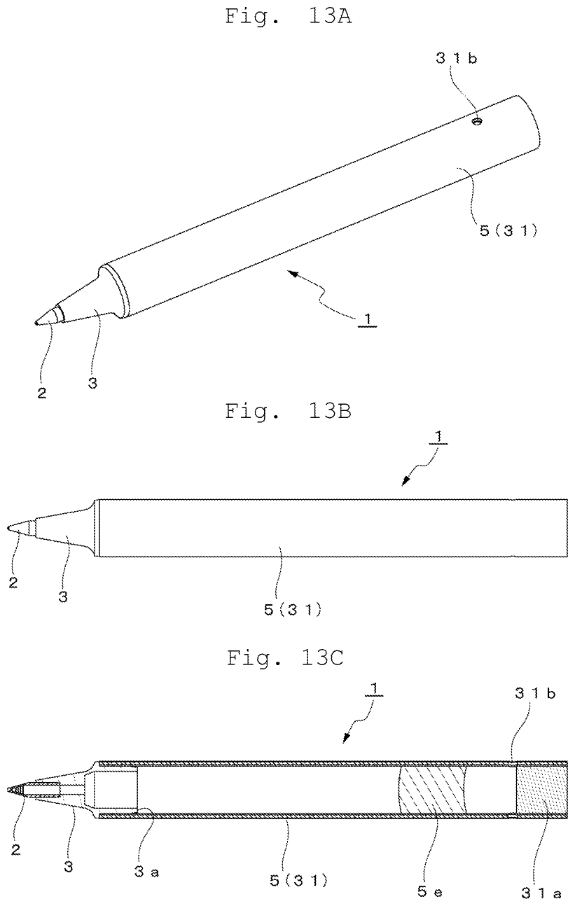

FIGS. 13A, 13B, and 13C show a third embodiment of the writing instrument according to the present invention and show an example in which the ink reservoir tube is adopted to a ballpoint writing instrument.

Also in the third embodiment, the ink reservoir tube 5 of the ink reservoir unit 1 is composed of a paper-based material and forms the barrel 31 as a grip.

Namely, as for the ink reservoir tube 5 in the example, similarly to the writing instrument of the second embodiment shown in FIGS. 12A, 12B, and 12C, the outer layer of the ink reservoir tube 5 is composed of a paper-based material, and preferably an ink reservoir tube 5 composed of two or more layers including a resin or aluminum layer as the inner layer is used.

Further, a three-layered structure shown in FIG. 1B or a five-layered structure shown in FIG. 3C, for example, can be employed for the ink reservoir tube 5 as appropriate.

The tail end of the ink reservoir tube 5 which also serves as a barrel 31 is closed with a tail cap 31a, and the front end of the ink reservoir tube 5 is attached by fitting with the connection part 3a formed on the rear half of the relay member 3. Further, a ballpoint pen tip as a writing member 2 is connected to the tip end of the ink reservoir tube 5 by way of the relay member 3.

The referential sign 5e in FIG. 13C indicates a backflow preventive body, a follower, that is in contact with the back end of the ink in the ink reservoir tube 5 and advances following the consumption of the ink. Therefore, the ink not shown in the drawing is stored in between the follower 5e and the relay member 3 of the ink reservoir tube 5. Further, the referential sign 31b in FIG. 13C indicates an air hole formed on the barrel 31.

As for the second embodiment of the writing instrument and the third embodiment of the writing instrument shown respectively in FIGS. 12A, 12B, and 12C and FIGS. 13A, 13B, and 13C, the corresponding connection part 3a to the ink reservoir tube 5 formed on the relay member 3 has a straight cylinder shape. Therefore, a certain connection strength is imparted to the ink reservoir tube 5, also serving as a barrel 31 connected by fitting, by applying an adhesive to the connection part 3a in advance.

In the writing instruments according to the present invention, to secure the connection strength of the front end of the ink reservoir tube 5 also serving as a barrel 31, various kinds of locking means and reinforcing members described based on FIGS. 2A through 10B can be adopted as appropriate. With this, writing instruments having excellent practicability in which a certain connection strength of the ink reservoir tube 5 is secured can be provided.

### LIST OF REFERENTIAL SIGNS

1 ink reservoir unit
2 writing member
2a connection part
2b writing ball
2c support member
3 relay member
3a connection part
3b tapered portion
3c male thread
3e tubular body
5 ink reservoir tube
5a1 base layer
5al first base layer
5a2 second base layer
5b inner layer
5c outer layer
5d resin layer
11 locking means
11a male thread
12 second locking means (annular locking member)
12a tapered surface
12b falling portion
13 third locking means (protrusion)
13a tapered surface
13b falling portions
14 fourth locking means
15 fifth locking means
16 ring-shaped reinforcing member
17 reinforcing member, having a C character shape cross-section
18 fastening ring
18a press-contact surface
18b female thread
19 garter spring
20 press ring
21 front barrel (barrel)
22 rear barrel (barrel)
23 tip end opening
31 barrel
32 cap
33 ink occluding body

1. An ink reservoir unit, comprising
an ink reservoir tube formed using paper as a based material;
wherein one end of the ink reservoir tube is connected with a connection part formed to a writing member or formed on a relay member holding the writing member.

2. The ink reservoir unit according to claim 1,
wherein a first locking means utilizing a male thread is formed on the outer peripheral surface of the writing member or the relay member at the connection part at which the ink reservoir tube is connected with the writing member or the relay member holding a writing member, and wherein the ink reservoir tube is connected by the first locking means to the writing member or the relay member.

3. The ink reservoir unit according to claim 1,
wherein a second locking means is provided at the connection part at which the ink reservoir tube is connected with the writing member or the relay member holding a writing member and comprises a plurality of annular locking members formed along the axial direction having a tapered face with the diameter increasing toward a tip end of the writing member and a falling portion whose diameter reduces at an acute angle following the tapered face, and wherein the ink reservoir tube is connected by the second locking means with the writing member or the relay member.

4. The ink reservoir unit according to claim 1,
wherein a third locking means is provided at the connection part at which the ink reservoir tube is connected with the writing member or the relay member holding a writing member and the third locking means comprises a plurality of protrusions that are formed discontinuously along the circumferential and axial direction having a tapered face gradually rising toward the tip end of a writing member and a falling portion whose diameter reduces at an acute angle following the tapered face is formed, and wherein the ink reservoir tube is connected by the third locking means with the writing member or the relay member.

5. The ink reservoir unit according to claim 1,
wherein a ring-shaped reinforcing member is fitted to the connection part at which the ink reservoir tube is connected with a writing member or the relay member holding a writing member along the outer peripheral surface of the ink reservoir tube.

6. The ink reservoir unit according to claim 1,
wherein a ring-shaped reinforcing member having a C-shaped cross-section perpendicular to the axial direction is fitted to the ink reservoir tube along the outer peripheral surface thereof at the connection part at which the ink reservoir tube is connected with a writing member or the relay member holding a writing member.

7. The ink reservoir unit according to claim 1,
wherein at the connection part at which the ink reservoir tube is connected with a writing member or the relay member holding a writing member a fourth locking means is provided that comprises a tapered portion formed on the writing member or the relay member to which the front end opening of the ink reservoir tube is to be inserted and a fastening ring having a press-contact face that is pressingly in contact with the outer surface of the ink reservoir tube at the tapered portion, and
wherein the ink reservoir tube is connected by the fourth locking means to the writing member or the relay member.

8. The ink reservoir unit according to claim 7, wherein the fastening ring is provided with a female thread that is to be screwed into the male thread provided on the writing member or the relay member.

9. The ink reservoir unit according to claim 1,
wherein at the connection part at which the ink reservoir tube is connected with a writing member or the relay member holding a writing member a fifth locking means is provided that comprises a cylindrical body formed on the writing member or the relay member and to which the front end of the ink reservoir tube is inserted, a garter spring (an annular spring) housed in the bottom portion of the cylindrical body and being pressingly in contact with the front end of the ink reservoir tube and a pressing ring housed in the cylindrical body to position the garter spring at the bottom portion of the cylinder, and wherein the ink reservoir tube is connected by the fifth locking means to the writing member or the relay member.

10. A writing instrument housing the ink reservoir unit for writing instruments in a barrel recited in claim 1.

11. A writing instrument, wherein the ink reservoir tube in the ink reservoir unit for writing instruments recited in any one of claim 1 constitutes a barrel serving as a grip.
